(19) United States
(12) Patent Application Publication
(10) Pub. No.: US 2023/0234551 A1
(43) Pub. Date: Jul. 27, 2023

(54) DEVICE FOR CONTROLLING VEHICLE CONVENIENCE EQUIPMENT, AND VEHICLE HAVING THE SAME

(71) Applicants: Hyundai Motor Company, Seoul (KR); Kia Corporation, Seoul (KR)

(72) Inventors: Kiyeon KANG, Seoul (KR); Younsung YOON, Suwon-si (KR); Kyusub KWAK, Suwon-si (KR); Sang Dae KIM, Bucheon-Si (KR)

(73) Assignees: Hyundai Motor Company, Seoul (KR); Kia Corporation, Seoul (KR)

(21) Appl. No.: 18/080,278

(22) Filed: Dec. 13, 2022

(30) Foreign Application Priority Data
Jan. 21, 2022 (KR) 10-2022-0009091

(51) Int. Cl. B60W 10/30; B60S 3/06

(52) U.S. Cl. CPC B60W 10/30; B60S 3/06; B60W 2710/30; B60W 2555/20

(57) ABSTRACT

A device for controlling a vehicle convenience equipment includes a communicator configured to communicate with at least one sensor for recognizing a surrounding environment, and a processor configured to, in a vehicle washing mode, determine whether a vehicle washing is complete based on surrounding environment information recognized by the at least one sensor received through the communicator, and upon concluding that the vehicle washing is completed, control the communicator to transmit a return control signal for at least one electronic device whose operating state is changed before the vehicle washing mode is performed.

### CROSS-REFERENCE TO RELATED APPLICATION(S)

The present application claims priority to Korean Patent Application No. 10-2022-0009091, filed on Jan. 21, 2022, the entire contents of which is incorporated herein for all purposes by this reference.

### BACKGROUND OF THE PRESENT DISCLOSURE

### Field of the Present Disclosure

The present disclosure relates to a control device configured for safely and conveniently controlling a state of a vehicle before, during, and after washing a vehicle, and a vehicle including the same.

### Description of Related Art

Generally, vehicles, in addition to a basic driving function, perform various additional functions for user convenience, such as, a radio function, an audio function, a video function, a road guidance function (a navigation function), an air conditioning function, a seat heating function, an external image acquisition function (a black box function), an obstacle collision prevention function, and a communication function with an external user terminal, and the like.

For example, the external image acquisition function may include a function to obtain an image of a rear field of view while parking, a function to obtain an image of a front field of view while driving, and a function to obtain an image of a field of view in a blind spot where a driver's view is not secured, and the like.

To utilize various functions of such a vehicle, a vehicle washing is required.

However, while washing a vehicle, exterior, interior, and electronic devices of a vehicle may be damaged by water, detergent, and cleaning tools, which is directly related to safety issues.

Conventionally, to protect exterior, interior, and electronic devices of a vehicle, users remember all operation information regarding various electronic devices to be operated before washing a vehicle, and should manually operate various electronic devices before washing a vehicle based on the memory. If at least one electronic device among the electronic devices to be operated by users is not operated, at least one non-operated electronic devices by cleaning tools while washing a vehicle may be damaged.

Furthermore, after washing a vehicle, users need to manually re-operate the operated electronic devices directly. At the instant time, if at least one electronic device is not operated, which may cause inconvenience in driving.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a device configured for controlling a vehicle convenience equipment configured for determining whether vehicle washing is completed based on image information obtained during vehicle washing, and transmitting a return control signal for automatically performing a driving preparation mode in response to the vehicle washing completion determination to at least one electronic device, and a vehicle including the same.

Another aspect of the present disclosure is to provide a device configured for controlling a vehicle convenience equipment configured for transmitting a change control signal of an operating state for automatically performing a vehicle washing preparation mode in response to an ON instruction of a vehicle washing mode to at least one electronic device, and transmitting a return control signal of the operating state for automatically performing the driving preparation mode in response to an OFF instruction of the vehicle washing mode to at least one electronic device, and a vehicle including the same.

Additional aspects of the present disclosure will be set forth in part in the description which follows, and in part, will be obvious from the description, or may be learned by practice of the present disclosure.

In accordance with an aspect of the present disclosure, a device configured for controlling a vehicle convenience equipment includes a communicator configured to communicate with at least one sensor configured for recognizing a surrounding environment, and a processor configured to, in a vehicle washing mode, determine whether a vehicle washing is complete based on surrounding environment information recognized by the at least one sensor received through the communicator, and upon concluding that the vehicle washing is completed, control the communicator to transmit a return control signal for at least one electronic device whose operating state is changed before the vehicle washing mode is performed.

The at least one sensor may further include an image sensor configured for obtaining image information, and the processor is further configured to obtain color information or text information of a traffic light through the image information on the image sensor, and determine whether the vehicle washing is completed based on the obtained color information or the obtained text information of the traffic light.

The processor may be further configured to conclude that the vehicle washing is completed in response that vehicle washing completion information is received from a server through the communicator.

The processor may be further configured to generate a change control signal of the operating state of the at least one electronic device based on pre-stored setting information in response to an ON instruction of the vehicle washing mode received through the communicator, and control the communicator to transmit the generated change control signal of the operating state to the at least one electronic device.

The processor may be further configured to control the communicator to transmit the return control signal to the at least one electronic device in response to an OFF instruction of the vehicle washing mode received through the communicator.

The processor may be further configured to generate an ON instruction of the vehicle washing mode based on current location information received from the communicator.

The at least one electronic device may include at least one of: a wiper, a side mirror, a window glass, a sunroof, a handle, a first sensor, a second sensor, an air conditioner, a tailgate, a door, and a charging door in the vehicle.

The at least one sensor may further include an image sensor configured for obtaining image information, and the processor is further configured to generate an ON instruction of the vehicle washing mode based on the image information of the image sensor, generate a change control signal of the operating state of the at least one electronic device based on pre-stored setting information, and control the communicator to transmit the generated change control signal of the operating state to the at least one electronic device.

In accordance with another aspect of the present disclosure, a vehicle include at least one sensor configured for recognizing a surrounding environment, and a processor configured to determine whether a vehicle washing is complete based on surrounding environment information recognized by the at least one sensor in a vehicle washing mode, and upon concluding that the vehicle washing is completed, control the communicator to transmit a return control signal for at least one electronic device whose operating state is changed before the vehicle washing mode is performed.

The at least one sensor may further include a microphone, and the processor is further configured to determine whether the vehicle washing is completed based on sound information received through the microphone.

The vehicle may further include a speed detector and a shift lever, the processor is further configured to determine whether a position of the shift lever is a drive (D) stage or a reverse (R) stage according to a signal of the shift lever, determine whether a driving speed of the vehicle is equal to or greater than a reference speed based on driving speed information detected by the speed detector upon determining that the position of the shift lever is the D stage or the R stage, and conclude that the vehicle washing is completed upon determining that the driving speed is equal to or greater than the reference speed.

The at least one sensor may further include a distance sensor, the processor is further configured to determine whether the vehicle washing is completed based on detection information of the distance sensor.

The at least one sensor may further include an image sensor configured for obtaining image information, and the processor is further configured to determine whether a current location of the vehicle is an entrance to a vehicle wash based on the obtained image information of the image sensor, obtain a distance to the entrance of the vehicle wash based on the detection information of the distance sensor upon determining that the current location is the entrance to the vehicle wash, and transmit a change control signal of the operating state to the at least one electronic device based on the obtained distance information.

The at least one sensor may further include an image sensor configured for obtaining image information, and the processor is further configured to recognize an object based on the image information of the image sensor, obtain at least one of color information of a traffic light and exit information or text information of a vehicle wash based on information on the recognized object, and determine whether the vehicle washing is completed based on the obtained at least one information.

A change control signal of the operating state of the at least one electronic device may include at least one of a folding control signal of a side mirror, a closing control signal of a window glass, a closing control signal of a sunroof, a retracting control signal of a handle, a deactivating control signal of a first sensor, a deactivating control signal of a second sensor, an indoor air circulation control signal of an air conditioner, a locking control signal of a tailgate, a locking control signal of a door, and a locking control signal of a charging door in the vehicle.

The vehicle may further include an inputter, the processor is further configured to transmit a change control signal of the operating state to the at least one electronic device in response to an ON instruction of the vehicle washing mode received through the inputter.

The processor may be further configured to transmit the return control signal to the at least one electronic device in response to an OFF instruction of the vehicle washing mode received through the inputter.

The vehicle may further include a communicator, the processor is further configured to conclude that the vehicle washing is completed in response that vehicle washing completion information is received from a server of a vehicle wash through the communicator.

The return control signal of the operating state of the at least one electronic device may include at least one of a unfolding control signal of a side mirror, an opening control signal of a window glass, an opening control signal of a sunroof, a protruding control signal of a handle, an activating control signal of a first sensor, an activating control signal of a second sensor, an outdoor air circulation control signal of an air conditioner, a unlocking control signal of a tailgate, a unlocking control signal of a door, and a unlocking control signal of a charging door in the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an exterior of a vehicle according to an exemplary embodiment of the present disclosure;

FIG. 2A and FIG. 2B are views exemplarily illustrating a handle of a door of the vehicle shown in FIG. 1;

FIG. 3 is a view exemplarily illustrating an interior of a vehicle according to an exemplary embodiment of the present disclosure;

FIG. 4A and FIG. 4B are views exemplarily illustrating a screen in a vehicle wash setting mode of a vehicle according to an exemplary embodiment of the present disclosure;

FIG. 5 is a control schematic diagram of a vehicle according to an exemplary embodiment of the present disclosure;

FIG. 6 is a view exemplarily illustrating a vehicle washing state of a vehicle according to an exemplary embodiment of the present disclosure.

FIG. 7 is a view exemplarily illustrating before performing a vehicle washing mode of a vehicle according to an exemplary embodiment of the present disclosure;

FIG. 8 is a view exemplarily illustrating operating state information of electronic devices when a vehicle washing mode of a vehicle according to an exemplary embodiment of the present disclosure is turned on or off; and

FIG. 9 is a control flowchart of a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference will now be made in detail to the exemplary embodiments of the present disclosure, examples of which are illustrated in the accompanying drawings, wherein like reference numerals refer to like elements throughout. The present specification does not describe all elements of the disclosed exemplary embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Furthermore, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements included in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, various embodiments of the present disclosure will be described in detail with reference to the accompanying drawings.

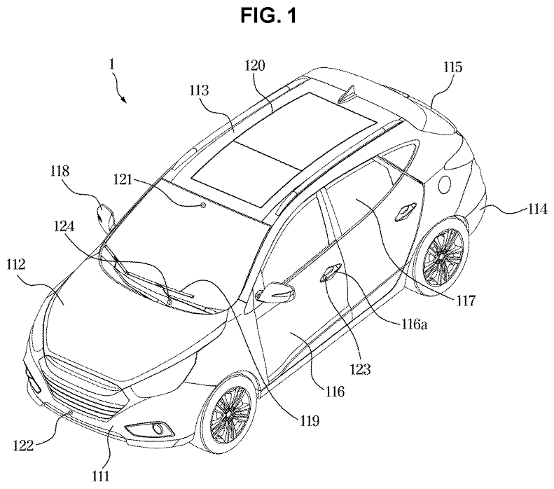

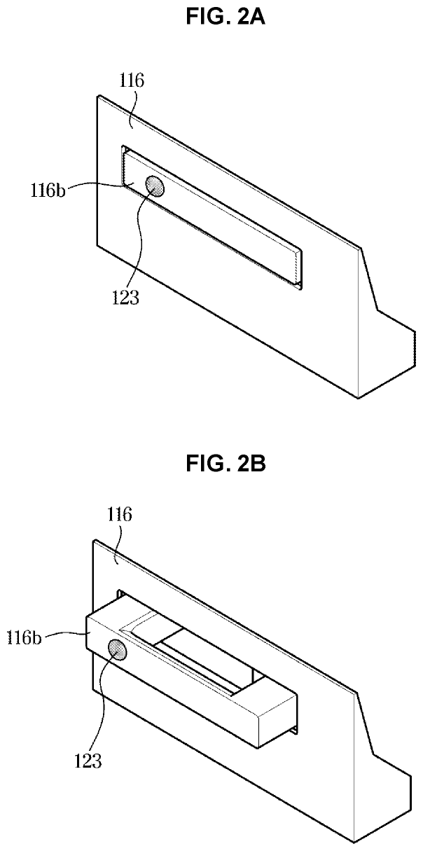

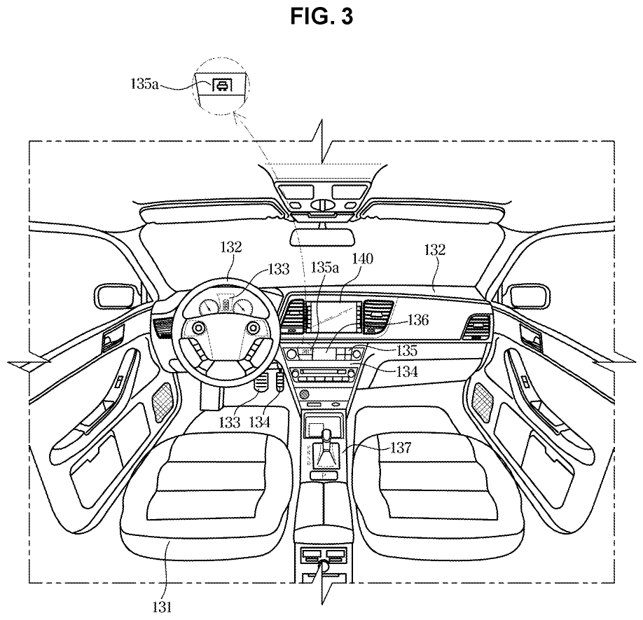

FIG. 1 is a view exemplarily illustrating an exterior of a vehicle according to an exemplary embodiment of the present disclosure, FIG. 2A and FIG. 2B are views exemplarily illustrating a handle of a door of the vehicle shown in FIG. 1, and FIG. 3 is a view exemplarily illustrating an interior of the vehicle according to an exemplary embodiment of the present disclosure.

A vehicle 1 includes a body including an interior and an exterior thereof, and a chassis in which mechanical devices necessary for driving are provided as the remaining parts except for the body.

As shown in FIG. 1, the exterior of the body may include a front panel 111, a bonnet 112, a roof panel 113, a rear panel 114, a tailgate 115, a plurality of doors 116 (front, rear, left and right doors), a window glass 117 provided to open or close each door 116, a side mirror 118 that provides a user with a field of view toward a rear of the vehicle 1, and a wiper 119 provided on a front window glass. The wiper 119 wipes raindrops or snow while moving left and right on the window glass to secure a forward field of view in rainy or snowy weather.

The door may provide as a sliding door of a sliding type.

When the vehicle is a battery vehicle, the exterior of the body may further include a charging door for opening and closing a charging port.

Each door 116 on the front, rear, left and right sides of the vehicle includes a handle 116b gripped by a user, and includes a first sensor 123 for detecting a user input for locking and unlocking the door 116.

The handle 116b of the door may be drawn into the inside of a panel surface of the door 116 or drawn out of the panel surface of the door.

As shown in FIG. 2A, the handle 116b may be in a retracted state positioned on the same surface as the panel surface of the door 116 by a movable member.

As shown in FIG. 2B, the handle 116b may be in a move out state protruding with a predetermined distance from the panel surface of the door 116 by the movable member.

The first sensor 123 for detecting a user input for locking and unlocking the door 116 may also be provided on the handle 116b which may be retractable (drawn into or out of).

In other words, the handle 116b may be drawn into or drawn out of the panel surface of the door 116 in response to a user input and a user authentication through the first sensor 123.

The vehicle 1 may include a roof panel 113, and further include a sunroof 120 provided on the roof panel 113 to open a partial area of the roof panel 113. An opening may be provided in a partial area of the roof panel 113.

The partial area of the roof panel 113 may be an area corresponding to the positions of a driver seat and a front passenger seat of the roof panel 113.

The partial area of the roof panel 113 may include an area corresponding to the positions of the driver seat and the front passenger seat and an area corresponding to the position of a rear seat, among areas of the roof panel.

In other words, the area of the sunroof 120 may extend from the area corresponding to the positions of the driver seat and the front passenger seat of the roof panel 113 to the area corresponding to the position of the rear seat.

The sunroof 120 may include a shielding panel provided in the opening of the roof panel 113, and may further include a sliding device that allows the shielding panel to move within the opening area and to move in and out a sliding manner. Herein, the shielding panel may include tempered glass.

The sunroof 120 may include an opening/closing control device configured for allowing the shielding panel to move within the opening area and to move vertically, or may include an opening/closing control device configured for rotationally moving in a tilt direction thereof.

The sunroof 120 may be adjusted to allow the outside light or air to enter the vehicle. Accordingly, the sunroof 120 makes it easy to ventilate the internal light or turbid air.

The sunroof 120 may be opened or closed in response to a user instruction, or may be opened to the degree of opening corresponding to the user instruction.

The vehicle 1 may include a second sensor 124 for detecting whether rain falls or not and an amount of precipitation.

In other words, the vehicle may further include the second sensor 124 provided on the wiper 119 or the front windshield glass, and the second sensor 124 outputs detection information (i.e., raindrop information and detected precipitation information) corresponding to whether rain falls or not and the amount of precipitation (amount of raindrop), respectively.

A camera 121 for obtaining an image of a surrounding environment may be provided on the exterior of the vehicle 1. A distance sensor 122 for detecting a distance to an obstacle may be further provided on the exterior of the vehicle 1.

The camera 121 obtains an image of a road around the vehicle in real time.

The camera 121 may obtains images in the front, rear, left and right directions of the vehicle, that is, images in different directions. In the instant case, the camera may be a plural. In other words, the plurality of cameras may have different viewing angles.

The camera 121 may include a charge couple device (CCD) or a complementary metal—oxide—semiconductor (CMOS) image sensor, and may include a three-dimensional space recognition sensor, such as KINECT (RGB-D sensor), TOF (Structured Light Sensor), stereo camera, and the like.

The camera 121 may include a camera of a black box, a camera of an autonomous driving control device configured for autonomous driving, a camera configured for detecting obstacles, and a surround view monitor (SVM) or an around view monitoring (AVM), and the like.

The camera 121 may be provided on a license plate, a grill, an emblem, a front panel or roof panel, and to be externally exposed of the vehicle.

The camera 121 may be provided on the front windshield glass in front of the vehicle, and may be provided on a window inside the vehicle to face the outside of the vehicle or on a rearview mirror inside the vehicle to face the outside of the vehicle.

The camera 121 converts shape information on an object around the vehicle into an electrical image signal, and transmits image signals corresponding to environments outside a host vehicle, at a current location of the host vehicle, to the processor. The image signals corresponding to environments outside the host vehicle, may include a road on which the vehicle travels and shape information on surround objects in front of the host vehicle.

The distance sensor 122 may be provided on at least one of the front panel 111 and the rear panel 114 of the vehicle. The distance sensor 122 may be plural.

The distance sensor 122 may include a light detection and ranging (LiDAR) sensor.

The LiDAR sensor is a non-contact distance detection sensor using the principle of laser radar.

The distance sensor 122 may include an ultrasonic sensor or a radar sensor.

The distance sensor 122 detects a distance to an obstacle located outside the host vehicle, for example, a preceding vehicle running in front of the host vehicle, a stationary object such as a structure located around a road, other vehicles approaching from the opposite lane, and pedestrians. Furthermore, the distance sensor 111 outputs detection information of the obstacles located in the front, rear, left and right sides of the host vehicle 1.

The vehicle, based on the detection information output from the distance sensor 122, may recognize the presence of an obstacle in a forward direction and the position of the obstacle. Herein, the position of the obstacle may include distance and direction thereof.

As shown in FIG. 3, the interior of the body may include a seat 131 on which an occupant sits, a dashboard 132, an instrument panel (i.e., cluster, 133) disposed on the dashboard 122 and displaying tachometer, speedometer, coolant thermometer, fuel gauge, turn indicator lamp, high beam indicator, warning lamp, seat belt warning lamp, odometer, shift lever indicator, door open warning lamp, engine oil warning lamp, low fuel warning lamp, a center fascia with vents and throttle of air conditioner, and a head unit 134 provided on the center fascia and receiving operation instructions of an audio device and the air conditioner.

The head unit may be provided with an inputter 135 for receiving operation instructions for various functions, and a display 136 for displaying information on functions being performed in the vehicle and information input by the user.

The inputter 135 may be implemented as at least one of a button, a key, a switch, and an operation lever, and may also be implemented as a jog dial or a touch pad for inputting a cursor movement command and a selection command displayed on a user interface 140.

The inputter 135 may include a vehicle wash button 135a that receives an ON instruction and an OFF instruction in a vehicle washing mode.

The vehicle 1 may further include a shift lever 137 provided on the center fascia and receiving an input of an operation position, and a parking button (electronic parking brake (EPB) button) located in a vicinity of the shift lever 137 or on the head unit 134 and receiving an operation instruction of the EPB device.

The user interface 140 may receive a user input and display an image corresponding to the user input.

The user interface 140 displays information on at least one of an audio mode, a video mode, a navigation mode, a DMB mode, and a radio mode.

The user interface 140 may receive a user input for a user setting mode, and change setting information for at least one item based on the received user input.

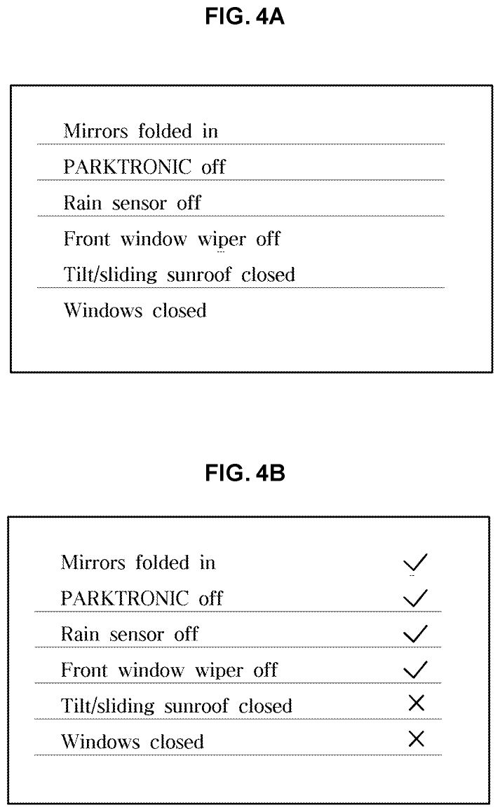

The user interface 140 may display items which may be set by a user in response that the ON instruction of the user setting mode is received. This will be described with reference to FIG. 4A and FIG. 4B. Herein, FIG. 4A and FIG. 4B are views exemplarily illustrating a screen in a vehicle wash setting mode of the vehicle according to an exemplary embodiment of the present disclosure.

As shown in FIG. 4A, the user interface 140 displays lists for setting a vehicle wash preparation mode for preparing vehicle wash, in response that an item of the vehicle wash setting mode is selected among the items of the user setting mode.

Lists to set the vehicle wash preparation mode may include folding of the side mirror, deactivation of the second sensor, the wiper off, the rear wiper off, automatic closing of the sunroof, automatic closing of the window glasses, and the like.

Lists to set the vehicle wash preparation mode may further include deactivation of the first sensor, retraction of the door handle, automatic locking of the doors, locking of the tailgate, and automatic switching of an outdoor air circulation mode.

As shown in FIG. 4B, the user interface 140 may display the lists selected by the user input and the unselected lists by dividing them into a selected mark v and an unselected mark x.

The chassis of the vehicle is a frame that supports the vehicle body, and may be provided with wheels disposed on the front, rear, left and right of the vehicle, respectively, a power device that generates a driving force necessary for driving a vehicle and regulates the generated driving force and applying the adjusted driving force to the front, rear, left and right wheels, a steering device, a braking device configured for applying a braking force to the front, rear, left and right wheels, respectively, and a suspension device.

The vehicle 1 may include a steering wheel of the steering device configured for adjusting a driving direction, a brake pedal pressed by a user according to a user's intentions to brake, and an accelerator pedal depressed by a user according to a user's intention to accelerate.

The vehicle 1 may further include various safety devices for safety and convenience of occupants.

For example, safety devices for a vehicle may include a collision warning device that notifies the existence of obstacles and obstacle information regarding the location of the obstacles to prevent collisions with obstacles around the host vehicle, an airbag control device configured for safety of occupants, such as the driver in the event of a vehicle collision, electronic stability control (ESC) that is configured to control a vehicle posture when accelerating or cornering the vehicle, and anti-lock brake system (ABS) that prevents wheel locking during sudden braking.

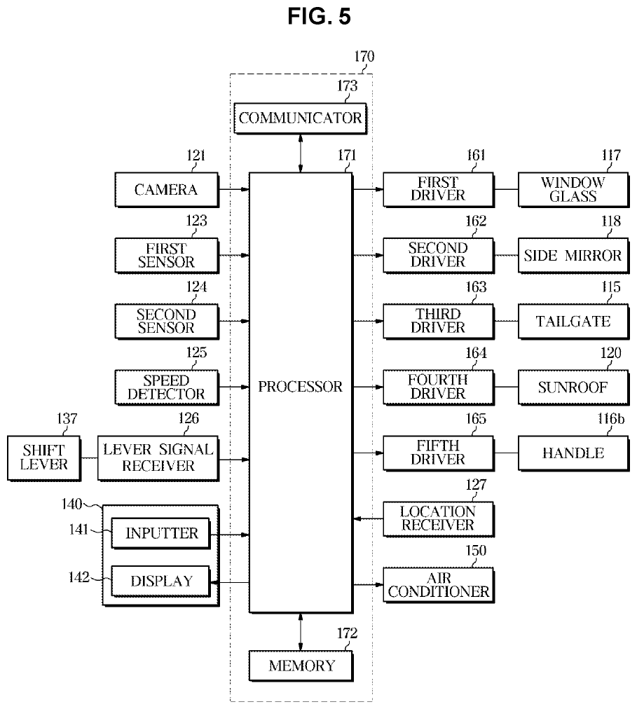

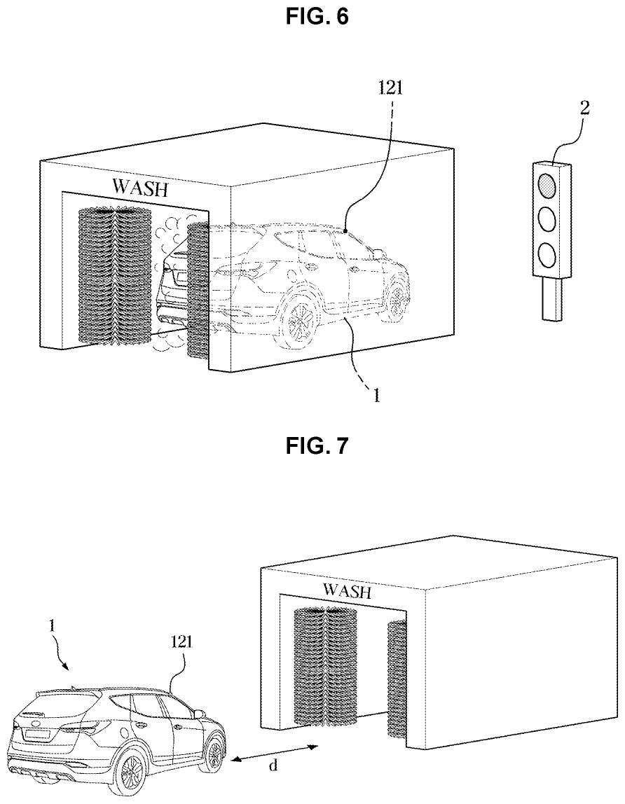

FIG. 5 is a control schematic diagram of a vehicle according to an exemplary embodiment of the present disclosure, which will be described with reference to FIGS. 6 to 8.

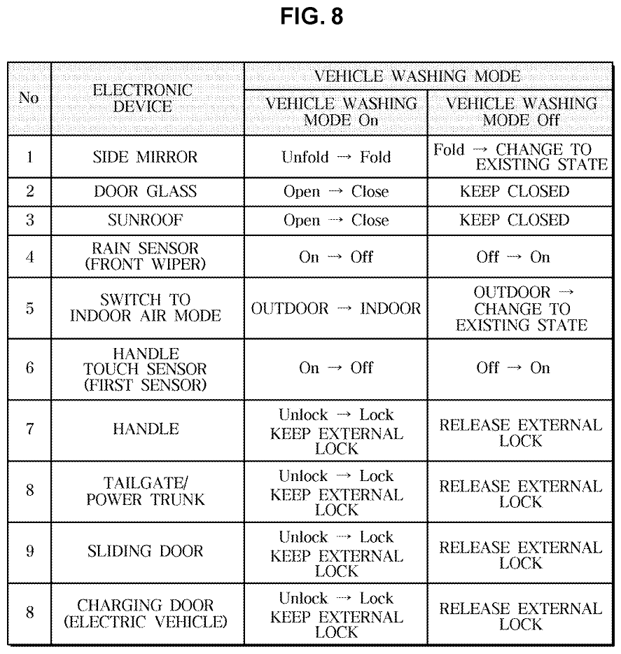

FIG. 6 is a view exemplarily illustrating a vehicle washing state of a vehicle according to an exemplary embodiment of the present disclosure, FIG. 7 is a view exemplarily illustrating before performing a vehicle washing mode of a vehicle according to an exemplary embodiment of the present disclosure, and FIG. 8 is a view exemplarily illustrating operating state information of electronic devices when a vehicle washing mode of a vehicle according to an exemplary embodiment of the present disclosure is turned on or off.

The vehicle 1 may include the camera 121, the first sensor 123, the second sensor 124, a speed detector 125, a lever signal receiver 126, a location receiver 127, the user interface 140, an air conditioner 150, a plurality of drivers 161-165, a processor 171, a memory 172, and a communicator 173.

The camera 121 obtains an image around the vehicle and transmits image information on the obtained image to the processor 171.

The first sensor 123 detects user information for user authentication. Herein, the user information may be information corresponding to a user input. The first sensor 123 may be provided on the exterior of the vehicle and externally exposed thereof.

The second sensor 124 detects whether rain falls or not and the amount of precipitation.

The speed detector 125 detects a driving speed of the vehicle and outputs driving speed information corresponding to the detected driving speed.

The speed detector 125 may include a wheel speed sensor provided on the front, rear, left and right wheels, respectively, to detect a rotation speed of each wheel, and may include an acceleration detector for detecting an acceleration of the vehicle.

The lever signal receiver 126 receives position information of the shift lever 137.

The lever signal receiver 126 receives an operation signal of the shift lever 137 and transmits the operation signal of the shift lever corresponding to the received operation signal to the processor 171.

The operation signal of the shift lever includes signals corresponding to a parking stage (P stage), a neutral stage (N stage), a drive stage (D stage), and a reverse stage (R stage).

The location receiver 127 receives location information for recognizing a current location of the vehicle.

The location receiver 127 may be a global positioning system (GPS) receiver that communicates with a plurality of satellites. Herein, the GPS receiver includes an antenna module for receiving signals from the plurality of GPS satellites, a software for obtaining a current location by use of distance and time information corresponding to the location signals of the plurality of GPS satellites, an outputter for outputting the obtained location information of the vehicle.

The user interface 140 may receive a user input and display an image corresponding to the user input.

The user interface 140 displays information on at least one of an audio mode, a video mode, a navigation mode, a digital multimedia broadcasting (DMB) mode, and a radio mode.

The user interface 140 may provide navigation information to the processor 171 when performing a navigation function.

The user interface 140 may include a display 142 and may further include an inputter 141.

The user interface 140 including the inputter 141 and the display 142 may be provided as a touch screen in which a touch panel and a display panel are integrated.

The inputter provided in the at least one of the head unit, the center fascia, and the steering wheel refers to as a first inputter, and the inputter of the user interface refers to as a second inputter.

The display provided on the at least one of the head unit, the center fascia, and the steering wheel refers to as a first display, and the display of the user interface refers to as a second display.

The second inputter 141 receives operation instructions for various functions which may be performed in the vehicle.

The second inputter 141 may receive an ON instruction and OFF instruction of the vehicle washing mode.

The second inputter 141 may receive setting information for at least one item in response to the user input.

The second display 142 may receive destination information when an autonomous driving mode or a navigation mode is performed, display map information in which route information from the current location to the destination is matched, and generate navigation information based on the route information and the map information and display the generated navigation information.

The second display 142 may display autonomous driving control information when the autonomous driving mode is performed, and also display images around the vehicle when the autonomous driving mode is performed.

The second display 142 may display a user setting window in response to the ON instruction of the user setting mode, and display items for which the user may change settings in the user setting window.

The second display 142 may display the on information and off information of the vehicle washing mode.

The second display 142, before the vehicle washing mode is performed, may display change information of an operating state of at least one electronic device corresponding to the vehicle wash preparation mode.

The second display 142, while the vehicle washing mode is being performed, may display operation information on the electronic devices operating in response to the vehicle wash preparation mode.

The second display 142, after completion of the vehicle washing mode, may display information on returning to the operating state of the at least one electronic device corresponding to the driving preparation mode.

The second display 142, when the vehicle arrives at the vehicle wash, may display vehicle wash guide information in response to a control instruction from the processor 171.

The air conditioner 150 performs heat exchange of the air inside the vehicle in response to a control instruction from the processor 171 so that the temperature of the air inside the vehicle reaches a target temperature set by the user.

The air conditioner 150 may perform air circulation based on an air circulation setting mode received.

Herein, the air circulation setting mode includes an outdoor air circulation mode in which air outside the vehicle is introduced into the interior, and an indoor air circulation mode in which air outside the vehicle is prevented from being introduced and only air inside the vehicle is circulated.

The first inputter 135 may be provided with an automatic circulation button for automatically switching the indoor air circulation mode and the outdoor air circulation mode.

The first driver 161 may open or close the window glass 117 in response to a control instruction of the processor 171, and adjust the degree of opening of the window glass 117 in response to a control command of the processor 171.

The second driver 162 may fold or unfold the side mirror 118 in response to a control instruction of the processor 171, and adjust yaw, roll, and pitch angles in response to a control instruction of the processor 171.

The third driver 163 may control a locking, unlocking, opening and closing of the tailgate 115 in response to a control instruction of the processor 171, and adjust the degree of opening of the tailgate 115 in response to a control instruction of the processor 171.

The fourth driver 164 may open or close the sunroof 120 in response to a control instruction of the processor 171, and adjust the degree of opening of the sunroof 120 in response to a control instruction of the processor 171.

The fifth driver 165 may allow the retractable handle 116b to be retracted or protruded in response to a control instruction of the processor 171.

The processor 171 is configured to control the execution of the automatic circulation mode to automatically switch the air circulation mode in response that the ON instruction is received from the automatic circulation button, and is configured to control the automatic circulation mode to be turned off in response that the OFF instruction is received from the automatic circulation button.

In response that the automatic circulation mode is off, the processor 171 may control the air conditioner 150 to perform the indoor air circulation in response to the indoor air circulation mode and control the air conditioner 150 to perform the outdoor air circulation in response to the outdoor air circulation mode.

In response that the user information is received through the first sensor 123, the processor 171 may perform the user authentication based on the received user information, and in response that the user authentication succeeds, control unlocking of the door 116 and also control unlocking of the tailgate 115.

In response that the user authentication is successful, the processor 171 may control to be protruded (pop out) the handle 116b of the door 116.

In response that the detection information is received through the second sensor 124, the processor 171 may obtain precipitation information based on the received detection information, and based on the obtained precipitation information, control the operation of the wiper 119 on and the speed of the wiper 119.

The processor 171 may control driving, parking, neutral, and reverse based on the position information of the shift lever 137 received through the lever signal receiver 126.

The processor 171 may control the opening of the window glass 117 based on an opening instruction of the window glass 117 received through the first inputter 135, and control the closing of the window glass 117 based on a closing instruction of the window glass 117 received through the first inputter 135.

The processor 171 may control the folding of the side mirror 118 based on a folding instruction of the side mirror 118 received through the first inputter 135, and control the unfolding of the side mirror 118 based on a unfolding instruction of the side mirror 118 received through the first inputter 135.

The processor 171 may control the opening of the tailgate 115 based on an opening instruction of the tailgate 115 received through the first inputter 135, and control the closing of the tailgate 115 based on a closing instruction of the tailgate 115 received through the first inputter 135. Herein, the tailgate 115 may be a power tailgate.

The processor 171 may control the opening of the sunroof 120 based on an opening instruction of the sunroof 120 received through the first inputter 135, and control the closing of the sunroof 120 based on a closing instruction of the sunroof 120 received from the first inputter 135.

The processor 171 performs the vehicle wash preparation mode in response to the ON instruction of the vehicle washing mode received through the first inputter 135 or the second inputter 141.

The processor 171 generates the change control signal of the operating state for the at least one electronic device based on vehicle wash preparation information stored in the memory 172 when the vehicle wash preparation mode is performed, and transmits the generated change control signal of the operating state to the at least one of electronic devices.

The processor 171 performs the driving preparation mode in response to the OFF instruction of the vehicle washing mode received through the first inputter 135 or the second inputter 141.

The processor 171 generates the return control signal of the operating state of the at least one electronic device based on the driving preparation information stored in the memory 172 when the driving preparation mode is performed, and transmits the generated return control signal of the operating state to the at least of the electronic devices.

The change control signal of the operating state of the at least one electronic device may be a signal for performing an operation opposite to the return control signal of the operating state of the at least one electronic device.

The processor 171 may determine whether the vehicle washing is completed based on the image information of the camera 121 while the vehicle washing mode is being performed, and upon determining that the vehicle washing is complete, generate the return control signal for the at least one electronic device whose operating state is changed before the vehicle washing mode is performed, and transmit the generated return control signal to the at least one electronic device.

The at least one electronic device whose operating state is changed before the vehicle washing mode is performed may include at least one electronic device whose operating state is manually manipulated by a user before the vehicle washing mode is performed.

The at least one electronic device whose operating state is changed before the vehicle washing mode is performed may include at least one electronic device selected as a target to perform the vehicle wash preparation mode by the vehicle wash setting mode.

As shown in FIG. 6, the processor 171 may recognize an object based on the image information of the camera 121 during the execution of the vehicle washing mode, determine whether the recognized object 2 is a traffic light, recognize a color of the object upon determining that the recognized object is a traffic light, and conclude that the vehicle washing is completed upon determining that the identified color is a predetermined color. For example, the predetermined color may be green, which is a color for instructing driving.

The processor 171 may recognize an object based on the image information of the camera 121 while the vehicle washing mode is being performed, determine whether the recognized object is a text, determine whether the text of the recognized object is a predetermined text upon determining that the recognized object is a text, and conclude that the vehicle washing is completed upon determining that the text of the recognized object is the predetermined text. For example, the predetermined text may be a text for instructing driving or a text indicating completion of the vehicle washing.

The processor 171 may recognize an object based on the image information of the camera 121 while the vehicle washing mode is being performed, determine whether the recognized object is an object corresponding to an exit of a vehicle wash, and conclude that the vehicle washing is completed upon determining that the recognized object is an object corresponding to the exit of the vehicle wash. Herein, the object corresponding to the exit of the vehicle wash may include information on the object obtained through learning.

The processor 171 may recognize a sound based on sound information received through a microphone, and conclude that the vehicle washing is completed upon determining that the identified sound is a predetermined sound. The predetermined sound may be a sound for instructing completion of the vehicle washing or a sound for instructing driving.

The processor 171 may recognize a voice based on sound information received through a microphone, convert the identified voice into a text, and conclude that the vehicle washing is completed upon determining that the converted text is a text corresponding to completion of the vehicle washing.

The microphone may be provided on the exterior of the vehicle or may be provided on the interior of the vehicle.

The processor 171 may determine whether the position of the shift lever is D stage or R stage based on the position information on the shift lever 137 received by the lever signal receiver 126, determine whether the driving speed is equal to or greater than a reference speed based on the driving speed information detected by the speed detector 125 upon determining that the position of the shift lever is D stage or R stage, and conclude that the vehicle washing is completed upon determining that the driving speed is equal to or greater than the reference speed.

The processor 171 may determine whether the vehicle washing is completed based on information detected by the distance sensor 122 while the vehicle washing mode is being performed.

For example, the processor 171 may determine whether a front obstacle adjacent to the vehicle exists based on the detection information of the distance sensor provided on the front panel, determine whether a rear obstacle adjacent to the vehicle exists based on the detection information of the distance sensor provided on the rear panel, and conclude that the vehicle washing is completed upon determining that the rear obstacle exists within a predetermined distance in a state where the front obstacle does not exist within a predetermined distance.

The processor 171 may obtain motion information on the surrounding obstacles based on detection information of a driver assistance device configured for parking while the vehicle washing mode is being performed, and determine whether the vehicle washing is completed based on the obtained motion information on the surrounding obstacles. Herein, the surrounding obstacles may be a cleaning tool at a vehicle wash. The driver assistance device configured for parking may include a rear camera and a distance sensor provided on the rear panel.

The processor 171 may recognize an object based on the image information of the camera 171, determine whether the recognized object is an object corresponding to an entrance to a vehicle wash, determine that the current location is the entrance to the vehicle wash upon determining that the recognized object is an object corresponding to the entrance to the vehicle wash and generate the change control signal of the operating state of the at least one electronic device, and transmit the generated change control signal of the operating state to the at least one electronic device.

As shown in FIG. 7, the processor 171 may recognize an object based on the image information of the camera 121, determine whether the recognized object corresponds to an entrance to a vehicle wash, determine that the current location is the entrance to the vehicle wash upon determining that the recognized object is an object corresponding to the entrance to the vehicle wash, determine whether a distance to the entrance to the vehicle wash is a reference distance based on the detection information of the distance sensor 122, generate the change control signal of the operating state of the at least one electronic device upon determining that the distance to the entrance to the vehicle wash is the reference distance, and transmit the generated change control signal of the operating state to the at least one electronic device.

When generating the change control signal of the operating state of the at least one electronic device, the processor 171 may generate the change control signal of the operating state of the at least one electronic device based on pre-stored vehicle wash preparation information corresponding to the vehicle wash preparation mode.

When generating the change control signal of the operating state of the at least one electronic device, the processor 171 may maintain and control the operating state of the at least one electronic device based on the pre-stored vehicle wash preparation information corresponding to the vehicle wash preparation mode.

The processor 171 determines whether the current location is a vehicle wash based on current location information received by the location receiver 127, and transmits the change control signal of the operating state to the at least one electronic device upon determining that the current location is the vehicle wash.

As shown in FIG. 8, the change control signal of the operating state of the at least one electronic device, which is a signal output when the vehicle washing mode is turned on, may include a folding control signal of the side mirror, a closing control signal of the window glass (also referred to as door glass), a closing control signal of the sunroof, a retracting control signal of the door handle, a deactivating control signal of the first sensor (a handle touch sensor), a deactivating control signal of the second sensor (a rain sensor), an indoor air circulation control signal of the air conditioner, a locking control signal of the tailgate, a locking control signal of the door (or sliding door), and a locking control signal of the charging door.

In the case of a vehicle provided with an external lock function, the processor 171 may output an external lock maintenance control signal of a device related to opening and closing when the vehicle washing mode is turned on.

For example, the device related to opening and closing may include at least one of a handle, a tailgate, a power trunk (also referred to as a power tailgate), a sliding door, a door, and a charging door.

The processor 171 may determine whether the destination is a vehicle wash based on the destination information, and upon determining that the destination is a vehicle wash, also determine whether the current location is a vehicle wash based on the current location information received from the location receiver 127.

The processor 171 may communicate with a server of a vehicle wash via the communicator 173, and upon determining that communication with the server is available, determine the current location as the vehicle wash.

The processor 171 may determine whether the current location is a vehicle wash based on the current location information, generate the ON instruction of the vehicle washing mode upon determining that the current location is a vehicle wash, and control execution of the vehicle wash preparation mode in response to the ON instruction of the vehicle washing mode.

The processor 171 may determine whether the current location is a vehicle wash based on the image information of the camera 121, generate the ON instruction of the vehicle washing mode upon determining that the current location is a vehicle wash, and control the execution of the vehicle wash preparation mode in response to the ON instruction of the vehicle washing mode.

The vehicle wash preparation mode includes changing the operating state of the at least one electronic device based on change control information of the operating state of the at least one electronic device set through the vehicle washing setting mode.

The execution of the vehicle wash preparation mode includes transmitting the change control signal of the operating state to the at least one electronic device based on information on the vehicle wash setting mode.

In response that vehicle washing completion information is received from the server of the vehicle wash through the communicator 173, the processor 171 transmits the return control signal or the maintenance control signal to the at least one electronic device.

As shown in FIG. 8, the return control signal of the operating state of the at least one electronic device, which is a signal output when the vehicle washing mode is turned off, may include a control signal of a pre-vehicle wash state of the side mirror, an activation control signal of the rain sensor, an activation control signal of the handle touch sensor, and a control signal of a pre-vehicle washing mode of the air conditioner.

For example, the processor may change the side mirrors to an unfolded state after washing the vehicle in response that the side mirrors is in a folded state before washing the vehicle, and maintain the side mirrors in an unfolded state after washing the vehicle in response that the side mirrors is in an unfolded state before washing the vehicle.

The processor may change the air circulation mode to the outdoor air mode after washing the vehicle in response that the air circulation mode is the outdoor air mode before washing the vehicle, and maintain the air circulation mode as the indoor air mode after washing the vehicle in response that the air circulation mode before washing the vehicle is the indoor air mode.

As shown in FIG. 8, the maintenance control signal of the operating state of the at least one electronic device may include a closing maintenance control signal of the door glass and a closing maintenance control signal of the sunroof.

When the vehicle is provided with an external lock function, the processor is configured to output a control signal for an external lock release of a device related to opening and closing when the vehicle washing mode is turned off

The device related to opening and closing may include at least one of a handle, a tailgate, a power trunk (or a power tailgate), a sliding door, and a charging door.

The processor 171 may control the execution of the driving preparation mode upon determining that the vehicle washing is completed based on the image information of the camera 121.

The processor 171 determines whether the vehicle washing is completed based on the communication with the server of the vehicle wash, and upon determining that the vehicle washing is complete control the execution of the driving preparation mode.

The processor 171 may determine whether the vehicle washing is completed based on the sound information of the microphone, and upon determining that the vehicle washing is complete control the execution of the driving preparation mode.

The driving preparation mode may include transmitting the return control signal of the operating state to the at least one electronic device.

As described above, by automatically performing the driving preparation mode after the vehicle washing is completed, it is possible to prevent a safety accident from occurring while driving. For example, when a user only unfolds the side mirror and does not activate the second sensor, the problem that visibility is not secured due to non-operating of the wiper in rain may be solved.

The processor 171 may be implemented as a memory that stores data for algorithms for controlling operations of components in the vehicle or programs that reproduce the algorithms, and a processor that performs the above-described operations using data stored in the memory. In the instant case, the memory and the processor may be implemented as separate chips. Alternatively, the memory and the processor may be implemented as a single chip.

The memory 172 may store setting information on at least one electronic device set in the user setting mode.

The memory 172 may also store operating state information of the electronic device operated by the user before washing the vehicle. This information may be automatically deleted after washing the vehicle.

The memory 172 may store vehicle wash preparation information and driving preparation information.

Herein, the vehicle wash preparation information may include change control information of the operating state of the at least one electronic device, and the driving preparation information may include return control information of the operating state of the at least one electronic device.

The memory 172 may be implemented as at least one of a nonvolatile memory device such as a cache, a read only memory (ROM), a programmable ROM (PROM), an erasable programmable ROM (EPROM), an electrically erasable programmable ROM (EEPROM), and flash memory, or a volatile memory device such as a random access memory (RAM), or a storage medium such as a Hard Disk Drive (HDD), a compact disk (CD-ROM), but is not limited thereto.

The communicator 173 may include one or more components that enable communication between components inside the vehicle, and may include, for example, at least one of a short-range communication module, a wired communication module, and a wireless communication module.

The short-range communication module may include various short-distance communication modules for transmitting and receiving signals using a wireless communication network in a short distance such as, a Bluetooth module, an infrared communication module, a radio frequency identification (RFID) communication module, a wireless local access network (WLAN) communication module, a near field communication (NFC) module, and a Zigbee communication module, and the like.

The wired communication module may include various wired communication modules such as, a local area network (LAN) module, a wide area network (WAN) module, or a value added network (VAN) module, as well as include various cable communication modules such as, a universal serial bus (USB) module, high definition multimedia interface (HDMI), digital visual interface (DVI), recommended standard232 (RS-232), a power line communication, and plain old telephone service (POTS), and the like.

The wired communication module may further include local interconnect network (LIN).

The wireless communication module, in addition to a Wifi module and a wireless broadband (Wibro) module, may include a wireless communication module supporting various wireless communication methods such as, global system for mobile communication (GSM), code division multiple access (CDMA), wideband code division multiple access (WCDMA), universal mobile telecommunications system (UMTS), time division multiple access (TDMA), long term evolution (LTE), and ultra wide band (UWB) modules, and the like.

The processor 171, the memory 172, and the communicator 173 may be components of a control device for convenient equipment 170. The control device for convenience and safety equipment 170 may communicate with various components of the vehicle through the communicator 173 and control operations of the exterior, interior, and electronic devices before and after washing the vehicle.

At least one component may be added or deleted according to the performance of the components of the control device 170 for convenience equipment. Furthermore, it will be readily understood by those of ordinary skill in the art that mutual positions of the components may be changed corresponding to the performance or structure of the system.

Furthermore, the processor 171 may be a processor disposed in the vehicle 1.

On the other hand, each component shown in FIG. 5 may refer to software and/or hardware components such as a field programmable gate array (FPGA) and an application specific integrated circuit (ASIC).

At least one component may be added or deleted according to the performance of the components of the vehicle illustrated in FIG. 5. Furthermore, it will be readily understood by those of ordinary skill in the art that mutual positions of the components may be changed corresponding to the performance or structure of the system.

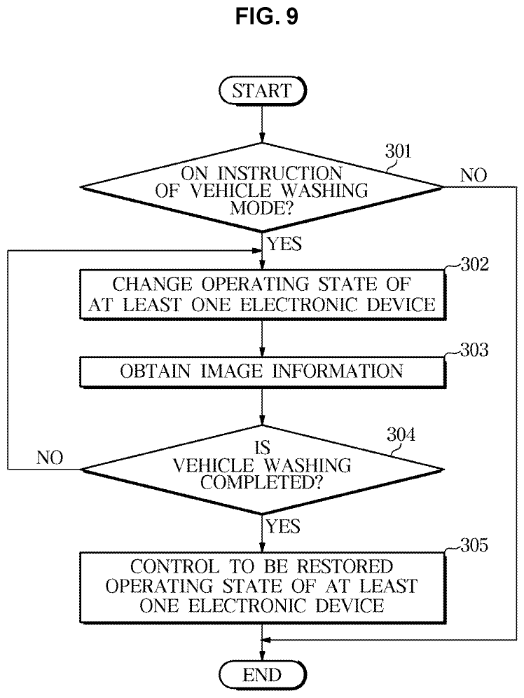

FIG. 9 is a flowchart illustrating a method for controlling a vehicle according to an exemplary embodiment of the present disclosure.

The vehicle determines whether the ON instruction of the vehicle washing mode is received through the first inputter 135 or the second inputter 141 (301).

In response to determining that the ON instruction of the vehicle washing mode is received, the vehicle performs the vehicle wash preparation mode.

The vehicle changes the operating state of the at least one electronic device based on the vehicle wash preparation information stored in the memory 172 while the vehicle wash preparation mode is being performed (302).

Herein, the vehicle wash preparation information includes change information of the operating state of the at least one electronic device generated by setting the vehicle wash preparation information through the vehicle wash setting mode.

For example, when the vehicle wash preparation information through the vehicle wash setting mode is set, if the folding control of the side mirror, the deactivation control of the first sensor, the indoor air circulation control, and the closing control of the sunroof are set, the vehicle controls to be changed the side mirrors from the unfolded state to the folded state and controls to be changed the first sensor from the activated state to the inactive state, in response to the reception of the ON instruction of the vehicle washing mode.

Furthermore, upon determining that the vehicle is in the outdoor air circulation mode the vehicle controls to be changed to the indoor circulation, and upon determining that the sunroof is in an open state the vehicle may control to be changed the sunroof to the closed state.

Furthermore, the vehicle may control to be maintained the indoor air circulation mode upon determining that the indoor air circulation mode is being performed, and control to be maintained the sunroof in a closed state upon determining that the sunroof is in the closed state.

The vehicle may obtain the image information through the camera 121 while the vehicle washing mode is being performed (303), and determine whether the vehicle washing is completed based on the obtained image information (304).

For example, the vehicle may recognize an object based on the image information of the camera 121 while the vehicle washing mode is being performed, determine whether the recognized object is a traffic light, recognize a color of the object upon determining that the recognized object is a traffic light, and conclude that the vehicle washing is completed upon determining that the identified color is a predetermined color. For example, the predetermined color may be green, which is a color for instructing driving.

Furthermore, the vehicle may determine whether the vehicle washing is completed in response to the OFF instruction of the vehicle washing mode received through the first inputter 135 or the second inputter 141.

Upon determining that the vehicle washing is complete, the vehicle controls to be restored the operating state of the at least one electronic device (305).

The vehicle may restore the operating state of the at least one electronic device whose operating state is changed before the vehicle washing mode is performed.

For example, the vehicle may control to be changed the side mirrors from the folded state to the unfolded state and to be returned the first sensor from the inactive state to the active state, in response to the reception of the ON instruction of the vehicle washing mode.

Furthermore, the vehicle may control to be changed the indoor air circulation mode to the outdoor air circulation mode, and to be returned the sunroof from the closed state to the open state.

Furthermore, upon determining that the vehicle is in the indoor air circulation mode before washing the vehicle, the vehicle may control to be maintained the indoor air circulation mode, and upon determining that the sunroof is in the closed state, the vehicle may control to be maintained the closed state of the sunroof

In other words, the at least one electronic device whose operating state is changed before the vehicle washing mode is performed may be the same as the at least one electronic device whose operating state is restored after the vehicle washing is completed.

As described above, the vehicle may improve user convenience by automatically restoring the operating state of the electronic device whose operating state is changed before washing the vehicle after washing the vehicle.

As is apparent from the above, various embodiments of the present disclosure may improve user convenience and improve driving safety by automatically performing the driving preparation mode after vehicle washing based on the image information during vehicle washing.

Furthermore, various embodiments of the present disclosure, by automatically performing the vehicle wash preparation mode before vehicle washing in response to the ON instruction of the vehicle washing mode, may prevent damage and failure of exterior, interior, and electronic devices during vehicle washing.

Furthermore, various embodiments of the present disclosure may improve marketability of a vehicle, and moreover increase user satisfaction, improve user reliability, and secure product competitiveness.

On the other hand, the above-described embodiments may be implemented in a form of a recording medium storing instructions executable by a computer. The instructions may be stored in a form of program code. When the instructions are executed by a processor, a program module is generated by the instructions so that the operations of the disclosed exemplary embodiments of the present disclosure may be conducted. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling a vehicle convenience equipment, the apparatus comprising:
a communicator configured to communicate with at least one sensor configured for recognizing a surrounding environment; and
a processor communicatively connected to the communicator and configured to:
in a vehicle washing mode, determine whether a vehicle washing is complete based on surrounding environment information recognized by the at least one sensor received through the communicator, and upon concluding that the vehicle washing is completed, control the communicator to transmit a return control signal for at least one electronic device whose operating state is changed before the vehicle washing mode is performed.

2. The apparatus of claim 1,
wherein the at least one sensor includes an image sensor configured for obtaining image information, and
wherein the processor is further configured to obtain color information or text information of a traffic light through the image information on the image sensor, and determine whether the vehicle washing is completed based on the obtained color information or the obtained text information of the traffic light.

3. The apparatus of claim 1, wherein the processor is further configured to conclude that the vehicle washing is completed in response that vehicle washing completion information is received from a server through the communicator.

4. The apparatus of claim 1, wherein the processor is further configured to generate a change control signal of the operating state of the at least one electronic device based on pre-stored setting information in response to an ON instruction of the vehicle washing mode received through the communicator, and control the communicator to transmit the generated change control signal of the operating state to the at least one electronic device.

5. The apparatus of claim 1, wherein the processor is further configured to control the communicator to transmit the return control signal to the at least one electronic device in response to an OFF instruction of the vehicle washing mode received through the communicator.

6. The apparatus of claim 1, wherein the processor is further configured to generate an ON instruction of the vehicle washing mode based on current location information received from the communicator.

7. The apparatus of claim 1, wherein the at least one electronic device includes at least one of:
a wiper, a side mirror, a window glass, a sunroof, a handle, a first sensor, a second sensor, an air conditioner, a tailgate, a door, and a charging door in the vehicle.

8. The apparatus of claim 1,
wherein the at least one sensor includes an image sensor configured for obtaining image information, and
wherein the processor is further configured to:
generate an ON instruction of the vehicle washing mode based on the image information of the image sensor,
generate a change control signal of the operating state of the at least one electronic device based on pre-stored setting information, and
control the communicator to transmit the generated change control signal of the operating state to the at least one electronic device.

9. A vehicle, comprising:
at least one sensor configured for recognizing a surrounding environment; and
a processor configured to determine whether a vehicle washing is complete based on surrounding environment information recognized by the at least one sensor in a vehicle washing mode, and upon concluding that the vehicle washing is completed, control a communicator communicatively connected to the processor to transmit a return control signal for at least one electronic device whose operating state is changed before the vehicle washing mode is performed.

10. The vehicle of claim 9,
wherein the at least one sensor includes a microphone, and
wherein the processor is further configured to determine whether the vehicle washing is completed based on sound information received through the microphone.

11. The vehicle of claim 9, further including:
a speed detector and a shift lever,
wherein the processor is further configured to determine whether a position of the shift lever is a drive (D) stage or a reverse (R) stage according to a signal of the shift lever, determine whether a driving speed of the vehicle is equal to or greater than a reference speed based on driving speed information detected by the speed detector upon determining that the position of the shift lever is the D stage or the R stage, and conclude that the vehicle washing is completed upon determining that the driving speed is equal to or greater than the reference speed.

12. The vehicle of claim 9,
wherein the at least one sensor includes a distance sensor, and
wherein the processor is further configured to determine whether the vehicle washing is completed based on detection information of the distance sensor.

13. The vehicle of claim 12,
wherein the at least one sensor further includes an image sensor configured for obtaining image information, and
wherein the processor is further configured to determine whether a current location of the vehicle is an entrance to a vehicle wash based on the obtained image information of the image sensor, obtain a distance to the entrance of the vehicle wash based on the detection information of the distance sensor upon determining that the current location is the entrance to the vehicle wash, and transmit a change control signal of the operating state to the at least one electronic device based on the obtained distance information.

14. The vehicle of claim 9,
wherein the at least one sensor includes an image sensor configured for obtaining image information, and
wherein the processor is further configured to recognize an object based on the image information of the image sensor, obtain at least one of color information of a traffic light and exit information or text information of a vehicle wash based on information on the recognized object, and determine whether the vehicle washing is completed based on the obtained at least one information.

15. The vehicle of claim 14, wherein a change control signal of the operating state of the at least one electronic device includes at least one of:
a folding control signal of a side mirror, a closing control signal of a window glass, a closing control signal of a sunroof, a retracting control signal of a handle, a deactivating control signal of a first sensor, a deactivating control signal of a second sensor, an indoor air circulation control signal of an air conditioner, a locking control signal of a tailgate, a locking control signal of a door, and a locking control signal of a charging door in the vehicle.

16. The vehicle of claim 9, further including an inputter,
wherein the processor is further configured to transmit a change control signal of the operating state to the at least one electronic device in response to an ON instruction of the vehicle washing mode received through the inputter.

17. The vehicle of claim 16, wherein the processor is further configured to:
transmit the return control signal to the at least one electronic device in response to an OFF instruction of the vehicle washing mode received through the inputter.

18. The vehicle of claim 9, wherein the processor is further configured to conclude that the vehicle washing is completed in response that vehicle washing completion information is received from a server of a vehicle wash through the communicator.

19. The vehicle of claim 9, wherein the return control signal of the operating state of the at least one electronic device includes at least one of an unfolding control signal of a side minor, an opening control signal of a window glass, an opening control signal of a sunroof, a protruding control signal of a handle, an activating control signal of a first sensor, an activating control signal of a second sensor, an outdoor air circulation control signal of an air conditioner, a unlocking control signal of a tailgate, a unlocking control signal of a door, and a unlocking control signal of a charging door in the vehicle.
